(19) United States
(12) Patent Application Publication
(10) Pub. No.: US 2018/0338878 A1
(43) Pub. Date: Nov. 29, 2018

(54) CASKET AND METHOD OF MAKING AND ASSEMBLING THE SAME

(71) Applicant: Cloud Caskets, LLC, Fredericksburg, TX (US)

(72) Inventor: Travis ARLITT, Fredericksburg, TX (US)

(21) Appl. No.: 15/607,081

(22) Filed: May 26, 2017

(51) Int. Cl. A61G 17/02; A61G 17/04

(52) U.S. Cl. CPC A61G 17/034; A61G 17/00; A61G 17/041

(57) ABSTRACT

A collapsible casket including a hollow base including a frame, and a plurality of internal intersecting members, where at least one intersecting member is disposed interior to the frame.

### FIELD OF THE DISCLOSURE

The invention generally relates to caskets and coffins, kits for caskets and coffins, and methods of making and assembling the same. In certain embodiments, the caskets and coffins are specifically designed to (adapted to) be quickly assemblable, disassemblable, and/or collapsible.

### BACKGROUND

Commonly, a casket or coffin is used to house and store a corpse for burial or cremation. Often, caskets or coffins may have multiple sides are adapted to open for open casket or coffin ceremonies during funerals. However, caskets or coffins may be made of expensive materials, or be difficult to store due to size and/or weight limitations at funeral homes or other applicable venues. Often, the storage, transportation, assembly, adornment, or other treatment of a casket or coffin during funeral procedures can be costly and inefficient. There remains a desire for caskets or coffins that are easily storable, adaptable to various furnishings, easily assembled, and easily transported in an efficient manner.

### BRIEF DESCRIPTION OF THE DRAWINGS

So that the manner in which the features and advantages are attained and can be understood in more detail, a more thorough description may be had by reference to the embodiments that are illustrated in the appended drawings. However, the drawings illustrate only some embodiments and therefore are not to be considered limiting of the scope.

FIG. 1 is a perspective view of an embodiment of an unassembled kit for constructing a casket.

FIG. 2 is a perspective side view of an embodiment of an assembled casket.

FIG. 3 is a perspective end view of an embodiment of an assembled casket.

FIG. 4 is a perspective end view of an embodiment of a base for an assembled casket.

FIG. 5 is a perspective end view of the base shown in FIG. 4 showing the internal configuration of the members of the base.

FIG. 6 is perspective side view of the base shown in FIG. 5.

FIG. 7 is a side view of a number of embodiments of a first side piece for an assembled casket.

FIG. 8 is side view of a number of embodiments of an attachment flange for a first side piece for an assembled casket.

FIG. 9 is a side view of a number of embodiments of a second side piece for an assembled casket.

FIG. 10 is an end view of a number of embodiments of a first end piece for an assembled casket.

FIG. 11 is an end view of a number of embodiments of a second end piece for an assembled casket.

FIG. 12 is an end view of a number of embodiments of a first lid piece for an assembled casket.

FIG. 13 is an end view of a number of embodiments of a first lid piece opposite the first end view of FIG. 12 for an assembled casket.

FIG. 14 is an end view of a number of embodiments of a second lid piece for an assembled casket.

FIG. 15 is an end view of a number of embodiments of a second lid piece opposite the first end view of FIG. 14 for an assembled casket.

FIG. 16 is an end view of a number of embodiments of an insert for a keeper for an assembled casket.

FIG. 17 is an end view of a number of embodiments of a backing for a keeper for an assembled casket.

FIG. 18 is a perspective side view of an embodiment of a lid piece for a casket.

FIG. 19 is a perspective side view of an embodiment of an assembled casket.

FIG. 20 is an end view of a number of embodiments of an insert and a backing for a keeper for an assembled casket.

FIG. 21 is a perspective side view of an embodiment of an assembled casket.

FIG. 22 is a perspective side view of an embodiment of an assembled casket.

FIG. 23 is a cutaway end view of an embodiment of an assembled casket.

FIG. 24 is a cutaway perspective side view of an embodiment of an assembled casket.

FIG. 25 is a cutaway end view of an embodiment of an assembled casket.

FIG. 26 is a cutaway perspective side view of an embodiment of an assembled casket.

FIG. 27 is a cutaway perspective side view of a component of an embodiment of an assembled casket.

FIG. 28 is a top view of a side piece and an end piece of an embodiment for an assembled casket.

FIG. 29 is an end view of an embodiment of an insert and a backing for a keeper.

The use of the same reference symbols in different drawings indicates similar or identical items.

### DETAILED DESCRIPTION OF THE INVENTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other embodiments can be used based on the teachings as disclosed in this application.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive- or and not to an exclusive-or. For example, a condition A or B is satisfied by any one of the following: A is true (or present) and B is false (or not present), A is false (or not present) and B is true (or present), and both A and B is true (or present).

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single item is described herein, more than one item may be used in place of a single item. Similarly, where more than one item is described herein, a single item may be substituted for that more than one item. Also, the use of “about” or “substantially” is employed to convey spatial or numerical relationships that describe any value or relationship that does not depart from the scope of the invention.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the casket and coffin arts.

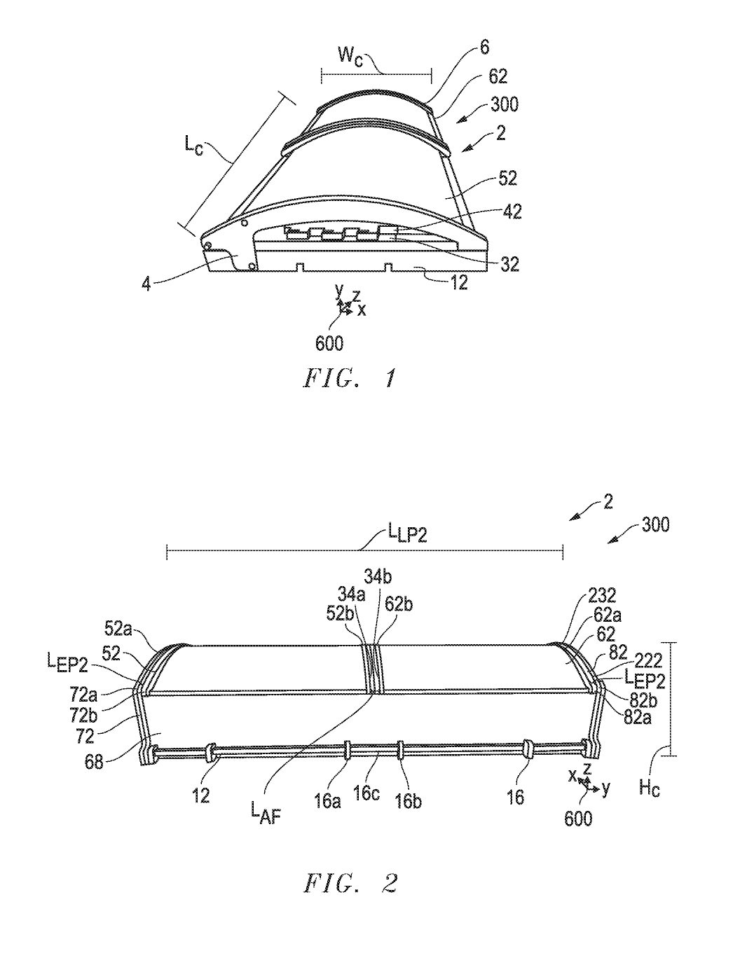

FIGS. 1-3, 19, and 21 depict a coffin or casket 2 oriented along axes 600 according to a number of embodiments. The axes 600 may define x (latitudinal, i.e. width), y (longitudinal, i.e. length), and z (vertical, i.e. height) directions. In a number of embodiments, the casket 2 may be collapsible. As used herein, the term “collapsible” will be understood to mean that the pieces of the casket can be quickly assembled to form the casket as well as quickly disassembled, or “broken down”, back to the constituent pieces of the casket, such as particularly by hand, without the need for the use of power tools. In a number of embodiments, the casket 2 may include components that may be assembled into a fully-formed casket. In a number of embodiments, the components may be provided as a kit 300 as shown in FIG. 1. The kit 300, due to the compact packing and alignment of the pieces, may provide ease of storage, assembly, and transportation. In a number of embodiments, the casket 2 or kit 300 may include a base 12 as a component. In a number of embodiments, the base may be hollow and comprise a plurality of internal interlocking members. In an embodiment, the interlocking members may extend longitudinally, vertically, or a combination thereof. In an embodiment, the internal interlocking members may comprise a cross shape, an octothorpe (also known as a pound sign or hash sign (#), or combination thereof. In a number of embodiments, the casket 2 or kit 300 may include a plurality of side pieces. In an embodiment, the casket or kit may include a first side piece 32 as a component, and a second side piece 42 as a component. In a number of embodiments, the casket 2 or kit 300 may include a lid. The lid may comprise a single piece or a plurality of pieces. In an embodiment, the lid may comprise at least one lid piece 52 as a component. In a number of embodiments, the casket 2 or kit 300 may include a lid comprising a plurality of lid pieces. In an embodiment, the lid may comprise at least a first lid piece 52a and a second lid piece 52b as components. In a number of embodiments, the casket 2 or kit 300 may include a plurality of end pieces. In an embodiment, the casket or kit may comprise a first end piece 72 as a component and a second end piece 82 as a component. In a number of embodiments, the casket 2 or kit 300 may include at least one keeper 102 as a component. In an embodiment, the keeper may comprise a slideably engageable locking component, with or without a housing, that is adapted to couple the side pieces and the end pieces together. In an embodiment, the keeper, when engaged, may form a modified mortise and tenon style joint, a modified tongue and groove joint, a modified dove tail joint, or a combination thereof. In an embodiment, the keeper may comprise a slideably engageable locking component adapted to couple together a modified mortise and tenon joint comprising a hook shaped tenon. In a number of embodiments, the casket 2 or kit 300 may include a plurality of keepers 102, 112, 122, 132 as components. The kit 300, as shown in FIG. 1, may be packaged to fit within a maximum combined length and girth (width+height) of 165 inches.

In a number of embodiments, as shown in FIGS. 1-3, the assembled casket 2 may have a length L_{C} as measured between a first longitudinal end 4 and a second longitudinal end 6. The assembled casket 2 may have a length L_{C} of at least 50 in., at least 60 in., at least 70 in., at least 80 in., at least 90 in., or at least 100 in. The assembled casket 2 may have a length L_{C} that may be no greater than 150 in., no greater than 140 in., no greater than 130 in., no greater than 120 in., no greater than 110 in., or no greater than 105 in. In a more specific embodiment, the assembled casket 2 may have a length L_{C} in a range of between about 48 in. to about 100 in. In a more specific embodiment, the assembled casket 2 may have a length L_{C} of no greater than 86 in.

In a number of embodiments, as shown in FIGS. 1-3, the assembled casket 2 may have a width W_{C} as measured between a first latitudinal side 8 and a second latitudinal side 10. The assembled casket 2 may have a width W_{C} of at least 10 in., at least 15 in., at least 20 in., at least 25 in., at least 30 in., or at least 35 in. The assembled casket 2 may have a width W_{C} that may be no greater than 60 in., no greater than 55 in., no greater than 50 in., no greater than 45 in., no greater than 40 in., or no greater than 35 in. In a more specific embodiment, the assembled casket 2 may have a width W_{C} in a range of between about 18 in. to about 45 in. In a more specific embodiment, the assembled casket 2 may have a width W_{C} of no greater than 30 in.

In a number of embodiments, as shown in FIGS. 1-3, the assembled casket 2 may have a height H_{C} as measured between its first vertical side 5 and its second vertical side 7. The assembled casket 2 may have a height H_{C} of at least 5 in., at least 7 in., at least 9 in., at least 11 in., at least 13 in., or at least 15 in. The assembled casket 2 may have a height H_{C} that may be no greater than 30 in., no greater than 25 in., no greater than 20 in., no greater than 15 in., no greater than 12 in., or no greater than 10 in. In a more specific embodiment, the assembled casket 2 may have a height H_{C} in a range of between about 12 in. to about 30 in. In a more specific embodiment, the assembled casket 2 may have a height H_{C} of no greater than 21 in.

In a number of embodiments, the casket 2 or any of its components can comprise a material with sufficient rigidity to withstand axial and longitudinal forces as desired. Components may comprise natural or artificial materials and can be solid essentially homogeneous materials, multi-component materials, laminates, composites, coated materials, veneered materials, encapsulated materials, or a combination thereof. In an embodiment, the casket components can comprise a polymer, a wood, a card board, or a combination thereof. In a particular embodiment, the casket 2 or any of its components may include wood including but not limited to cedar, fir, pine, birch, redwood, ash, cherry, mahogany, maple, oak, poplar, teak, walnut, spruce, Douglas fir, angiosperm, Philippine mahogany, rosewood, plywood, particle board, cardboard, combinations thereof, or may be another type. In a more particular embodiment, the casket 2 or any of its components may be entirely wood. The casket 2 or any of its components may be formed through a woodworking process including, but not limited to, wood carving, joinery, sawing, carpentry, woodturning, or may be another type. The casket 2 or any of its components can be finished through at least one of sanding, filing, scraping, bleaching, staining, varnishing, weathering, fuming, or may be finished a different way to provide a more aesthetic appearance. In a specific embodiment, the woodworking process can be accomplished with a router, in particular, a computer numerical control (CNC) router. In another specific example, woodworking can be accomplished through 3D printing, such as, but not limited to, 3D wood printing. The casket 2 or any of its components can be furnished with a fabric lining as known in the casket and coffin arts for a more aesthetic appearance. The casket 2 or any of its components can be furnished with an exterior pattern or adornment fixture for a more aesthetic appearance. The casket 2 or any of its components can be formed from a single piece, two pieces, or several pieces joined together by welding, adhesive, fasteners, threading, or any other suitable fastening means. The casket 2 or any of its components can be joined to another component by welding, adhesive, fasteners, threading, or any other suitable fastening means. The fastener may include a nail (metal, plastic or may be another type), a staple, a bolt, a screw, adhesive, or may be another type. In a particular embodiment, the fastener may include only non-metal nails.

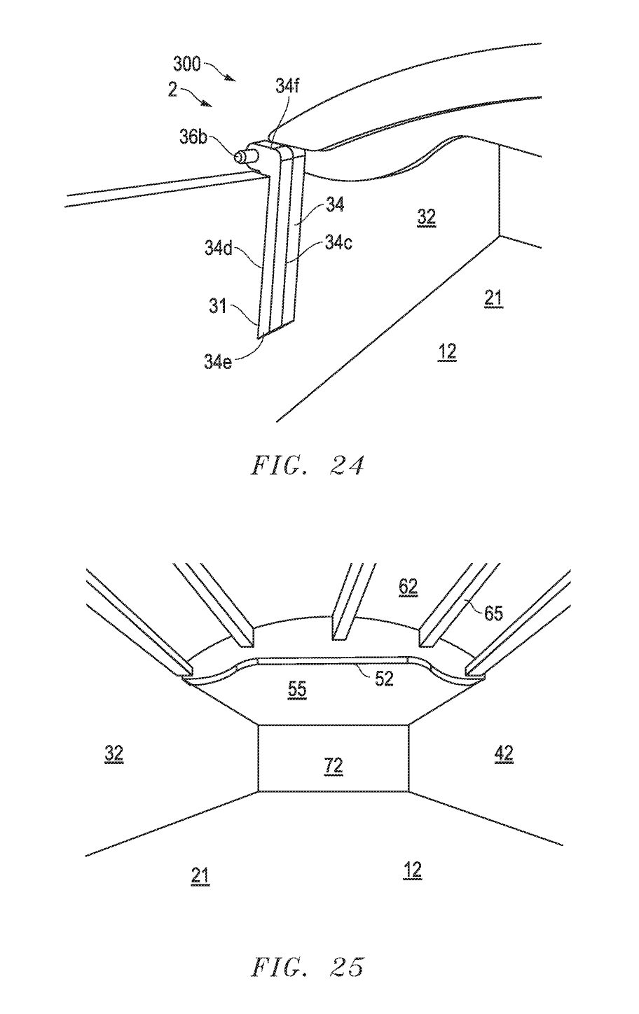

As shown in FIGS. 4-6, the casket 2 or kit 300 may include a base or torsion box 12. The base 12 may have a first longitudinal end 13 and a second longitudinal end 15. The base 12 may include a first base latitudinal side 17 and a second latitudinal side 19. The base 12 may be hollow, as show in FIGS. 4-6 and have a first vertical side (top) 21 and a second vertical side (bottom) 23 portions as shown in FIG. 4. In a number of embodiments, the base 12 may include a base main body 14 and at least one base handle 16. The least one handle 16 may include at least one first longitudinal end piece 16a, at least one second longitudinal end piece 16b, and at least one handle connecting portion 16c connecting the first longitudinal end piece 16a to the second longitudinal end piece 16b. In a particular embodiment, the handle 16 comprises at least two handle connecting portions 16c, 16c′. In a number of embodiments, a handle 16 may be disposed at the first longitudinal end 13, second longitudinal end 15, or somewhere between the longitudinal ends 13, 15 in the middle of the base 12. In a number of embodiments, the longitudinal ends 16a, 16b of the base handle 16 may define the first base latitudinal end or second latitudinal ends 17, 19 of the base 12. In a number of embodiments, at least one of the first longitudinal end 16a or the second longitudinal end 16b may include a side placement notch 97 as shown best in FIG. 23. The side placement notch 97 may accept a side piece into contact with the base 12. In another embodiment, a dowel may be used as an alternative to the side placement notch 97. In a number of embodiments, the handle connecting portion 16c may be adapted to allow a user to carry the casket 2 upon assembly. The handle connecting portion 16c may have a circular, oval, or polygonal cross-section. In a number of embodiments, the handle 16 may further include a void 28 or empty space in the latitudinal direction between the base main body 14 and the handle connecting portion 16c. In a number of embodiments, the base 12 may include a plurality of base handles 16 along at least one of its latitudinal sides 17, 19. In a particular embodiment, the base 12 may include 3 base handles 16 along each of its latitudinal sides 17, 19 as shown. In a number of embodiments, a base trim 191 may be positioned between base handles 16 as shown in FIG. 19. In a number of embodiments, as shown in FIG. 21, a plurality of base handles 16 may run substantially along at least one of the entire latitudinal sides 17, 19 of the casket 2 or base 12.

### Base (Torsion Box)

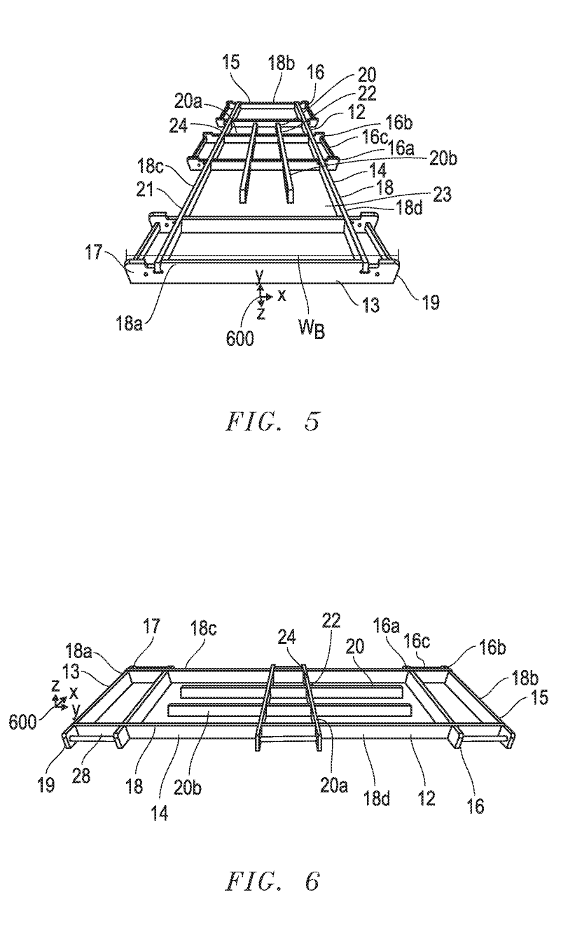

Still referring to FIGS. 4-6, in a number of embodiments, the base 12 or base main body 14 may include a frame 18. In an embodiment, the frame (also referred to herein as a torsion box) may comprise a plurality of latitudinal pieces (x-axis) and a plurality of longitudinal pieces (y-axis). The latitudinal and longitudinal pieces may intersect and interlock. The latitudinal pieces may be positioned to span from or across the longitudinal pieces at right angles, diagonally, or a combination thereof. In an embodiment, number of lateral pieces can vary, such as at least two, at least three, at least four, at least five, or at least six lateral pieces, may be disposed periodically along the length of the longitudinal pieces. In an embodiment, number of lateral pieces can vary, such as not greater than ten, not greater than nine, not greater than eight, not greater than seven, or not greater than six. In an embodiment, the lateral pieces may be disposed periodically along the length of the longitudinal pieces. In an embodiment, the frame may comprise two longitudinal pieces and two lateral pieces. In a particular embodiment, the frame 18 may have first and second longitudinal ends 18a, 18b. The frame 18 may have first and second latitudinal sides 18c, 18d. The frame 18 may define the external boundaries of the base main body 14 in the latitudinal directions. The frame 18 may define the first base longitudinal end 17 and second longitudinal ends 19 of the base 12 as shown. In a number of embodiments, the frame 18 may form a rectangular shape as shown. The first vertical side (top) 21 and second vertical side (bottom) 23 may define the external boundaries of the base 12 or base main body 14 in the vertical direction. In an embodiment, the frame may comprise a plurality of handles disposed along the length of the longitudinal members. In an embodiment, a handle may comprise two lateral pieces positioned in parallel and disposed intersecting across and with the longitudinal pieces. The handle may further comprise a hand grip or hand grips coupled to and disposed between the lateral pieces at the distal ends of the lateral pieces. In a specific embodiment, the handles 16 may extend axially away from the frame 18 as shown in FIGS. 4-6. In a number of embodiments, as shown in FIGS. 5-6, the base 12 or base main body 14 may include plurality of internal intersecting members 20. Internal intersecting members 20 may be understood as being at least two separate members, which form an intersection 22 interior to the frame 19 of the base 12 or base main body 14. The interior intersecting members may extend outward longitudinally, laterally, diagonally, or a combination thereof, from the center of the base as viewed from above. Alternatively, the interior intersecting members may extend inward from the outer sides of the frame toward the center of the base. The interior intersecting members can form various shapes, including polygons, cross shapes, and combinations thereof. In a particular embodiment, the intersecting members 20 may be wood boards formed into a joint 22 via a woodworking process. The joint may be a standard joint, a modified joint, or a combination thereof. The joint 22 may be a butt joint, an overlap joint, a bridle joint, a dowel joint, a mitre joint, a finger joint, a dovetail joint, a dado joint, a groove joint, a tongue and groove joint, a mortise and tenon joint, a birdsmouth joint, a cross lap joint, a splice joint, a biscuit joint, a pocket-hole joint, a biscuit joint, a floating tenon joint, a stitch and glue joint, a domino joiner, any combination thereof, or may be another type. In a particular embodiment, at least one intersecting member 20 can include a cut, groove, or slot to form the joint 22. In a number of embodiments, at least one intersecting member 20a may intersect, contact, or be joined to the frame 18. In a number of embodiments, at least one intersecting member 20a may form or be the same piece as the first longitudinal end piece 16a or second longitudinal end piece 16b of a base handle 16 or plurality of base handles as shown, particularly in FIG. 5. In a particular embodiment, at least one intersecting member 20a may form an intersection or joint 24 with the frame 18 along any of its sides 18a, 18b, 18c, and 18d. The joint 24 may be a butt joint, an overlap joint, a bridle joint, a dowel joint, a mitre joint, a finger joint, a dovetail joint, a dado joint, a groove joint, a tongue and groove joint, a mortise and tenon joint, a birdsmouth joint, a cross lap joint, a splice joint, a biscuit joint, a pocket-hole joint, a biscuit joint, a floating tenon joint, a stitch and glue joint, a domino joiner, any combination thereof, or may be another type. In a number of embodiments, an intersecting member 20 may form or be the same piece as the first base longitudinal end 17 or second longitudinal end 19 as shown. In a number of embodiments, the base 12 or base main body 14 may include at least one intersecting member 20b that may be disposed interior to the frame 18. In a number of embodiments, the base 12 or base main body 14 may include at least one intersecting member 20b that may be disposed entirely interior to the frame 18, in other words, at least one intersecting member 20b may not intersect the frame 18. In a number of embodiments, the base 12 or base main body 14 may include at least one intersecting member 20b that may be disposed interior to the frame 18 such that it lies within the edges of the first and second longitudinal ends 18a, 18b, and the edges of the first and second latitudinal sides 18c, 18d of the frame 18. In a number of embodiments, the base 12 or base main body 14 may include at least one intersecting member 20b that may be disposed completely within the frame in the latitudinal and longitudinal directions such that it does not intersect the frame 18 at any of its sides or ends 18a, 18b, 18c, 18d. In this way, the casket 2 or kit may be packaged in a smaller size or packaged more efficiently while being able to support a larger corpse. In a number of embodiments, any of the base 12, base main body 14, frame 18 or intersecting members 20 may be wood boards as shown. In a number of embodiments, any of the base 12, base main body 14, frame 18 or intersecting members 20 may be wood boards in sizes 1×2, 1×3, 1×4, 2×4, 2×6, 2×8, 4×4, 4×6, 6×6, a combination thereof, or may be another type. In a number of embodiments, the first vertical side (top) 21 and second vertical side (bottom) 23 portions may be wood sheets including, but not limited to, plywood.

In a number of embodiments, as shown in FIGS. 4-6, the base 12 may have a length L_{B} as measured between a first longitudinal end 13 and a second longitudinal end 15. The base 12 may have a length L_{B} of at least 50 in., at least 60 in., at least 70 in., at least 80 in., at least 90 in., or at least 100 in. The base 12 may have a length L_{B} that may be no greater than 150 in., no greater than 140 in., no greater than 130 in., no greater than 120 in., no greater than 110 in., or no greater than 105 in. In a more specific embodiment, the base 12 may have a length L_{B} in a range of between about 80 in. to about 82 in.

In a number of embodiments, as shown in FIGS. 4-6, the base 12 may have a width W_{B} as measured between a first latitudinal side 17 and a second latitudinal side 19. The base 12 may have a width W_{B} of at least 10 in., at least 15 in., at least 20 in., at least 25 in., at least 30 in., or at least 35 in. The base 12 may have a width W_{B} that may be no greater than 60 in., no greater than 55 in., no greater than 50 in., no greater than 45 in., no greater than 40 in., or no greater than 35 in. In a more specific embodiment, the base 12 may have a width W_{B} in a range of between about 30 in. to about 32 in.

In a number of embodiments, as shown in FIGS. 4-6, the base 12 may have a height H_{B} as measured between its first vertical side (top) 21 and its second vertical side (bottom) 23. The base 12 may have a height H_{B} of at least 0.5 in., at least 2 in., at least 4 in., at least 6 in., at least 8 in., or at least 10 in. The base 12 may have a height H_{B} that may be no greater than 30 in., no greater than 25 in., no greater than 20 in., no greater than 15 in., no greater than 12 in., or no greater than 10 in. In a more specific embodiment, the base 12 may have a height H_{B} in a range of between about 1.5 in. to about 3 in.

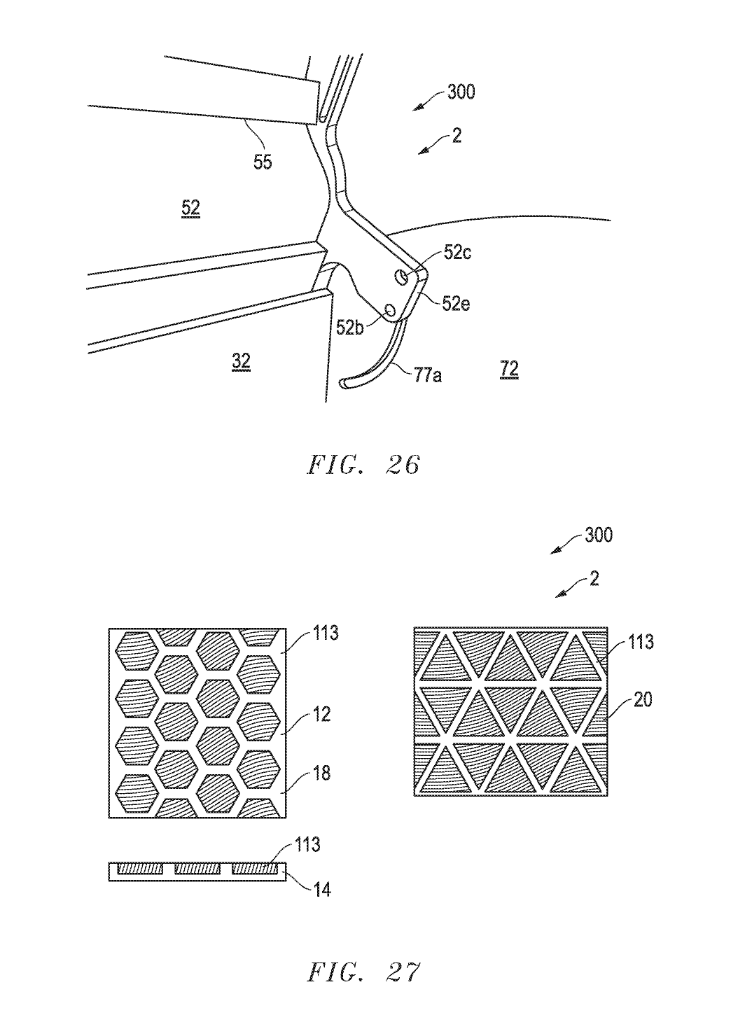

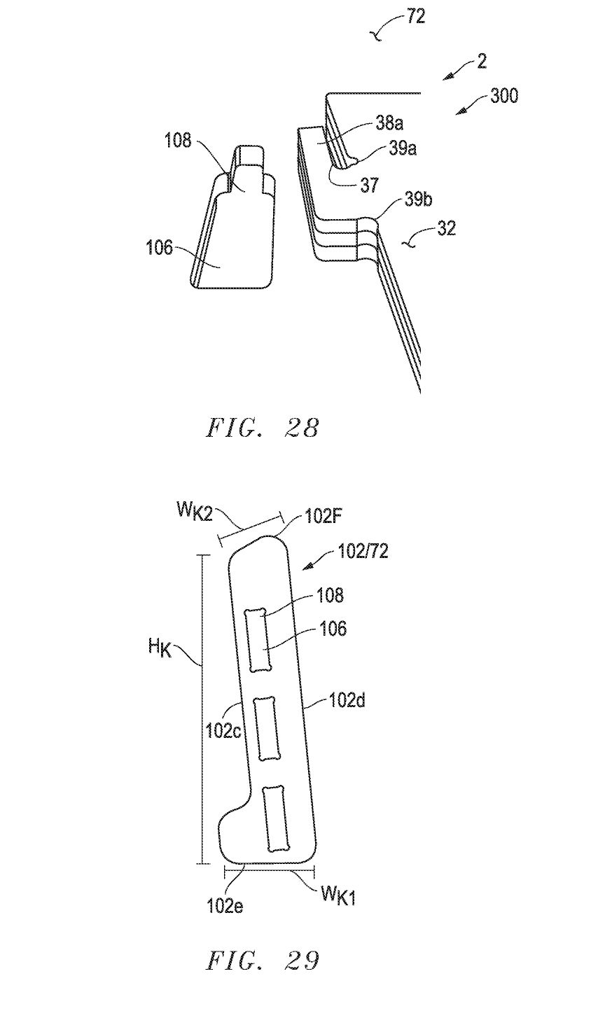

In a number of embodiments, the base 12, base main body 14, frame 18 or intersecting members 20, may include a plurality of voids 113 therein as shown in FIG. 27. The voids may be covered with fabric or unseen. In a number of variations, the base 12, base main body 14, frame 18 or intersecting members 20 may have a void volume of at least 20%, at least 30%, at least 40%, at least 50%, at least 60%, or at least 70% the volume of the base 12, base main body 14, frame 18 or intersecting members 20.

### First Side Piece

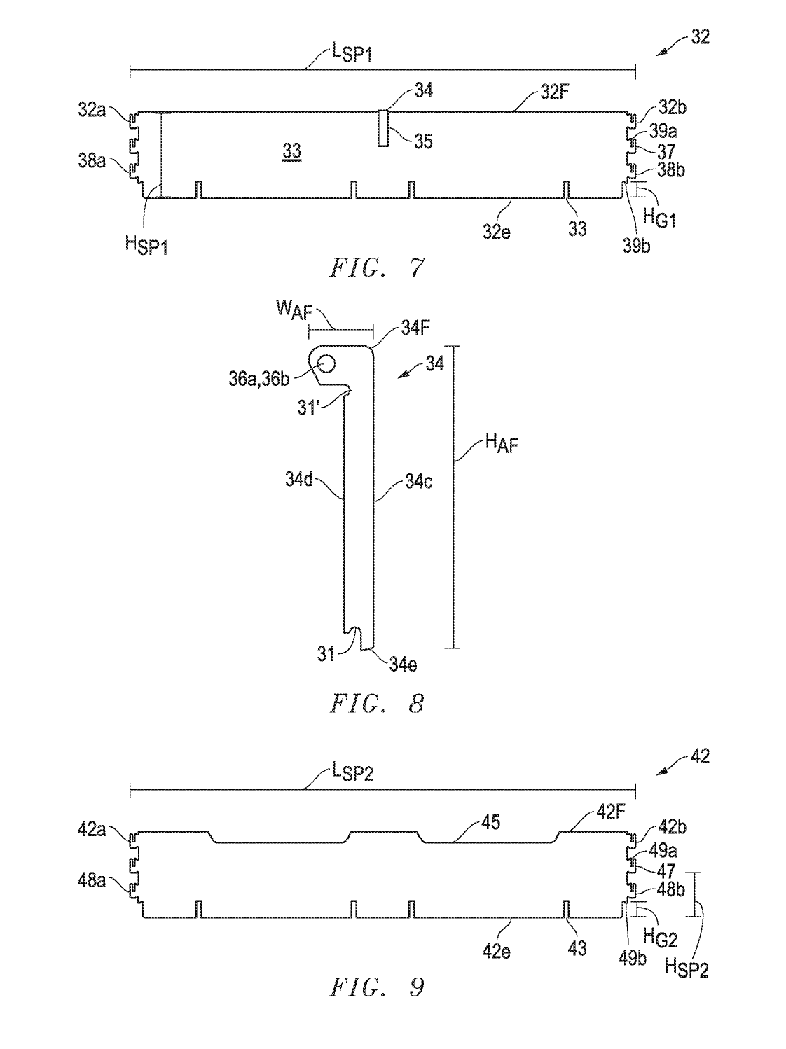

Referring to FIG. 7, in a number of embodiments, the casket 2 or kit 300 may include a first side piece 32. The first side piece 32 may have first and second longitudinal ends 32a, 32b. The first side piece 32 may have first and second latitudinal ends 32c, 32d. The first side piece 32 may have first and second vertical sides 32e, 32f. In a number of embodiments, the first side piece 32 may include at least one groove cut 33 located on its first vertical side 32e. The groove cut 33 may have a height H_{G1} of about ⅛, ¼, ⅓, ½ of the height H_{SP1} of the first side piece 32, or may be another ratio. In a number of embodiments, the first side piece 32 may further include at least one hook attachment 38a on its first longitudinal end 32a. In a number of embodiments, the first side piece 32 may further include a plurality of hook attachments 38a on its first longitudinal end 32a. In a number of embodiments, the first side piece 32 may further include at least one hook attachment 38b on its second longitudinal end 32b. In a number of embodiments, the first side piece 32 may further include a plurality of hook attachments 38b on its second longitudinal end 32b. The hook attachment 38a, 38b may be a butt, an overlap, a bridle, a dowel, a mitre, a finger, a dovetail, a dado, a groove, a tongue, a tenon, a birdsmouth, a cross lap, a splice, a biscuit, a pocket-hole, a floating tenon, a stitch, a domino, or may be another type. In a number of embodiments, the hook attachment 38a, 38b may include a U-shape 37 with a top groove 39a formed interior to the U-shape 37, and a bottom groove 39b formed underneath the U-shape 37. An alternative embodiment of the hook attachment 38a is shown in FIG. 28. In a number of embodiments, the first side piece 32 may be a wood board or assembly of wood pieces.

In a number of embodiments, as shown in FIG. 7, the first side piece 32 may have a length L_{SP1} as measured between a first longitudinal end 32a and a second longitudinal end 32b. The first side piece 32 may have a length L_{SP1} of at least 50 in., at least 60 in., at least 70 in., at least 80 in., at least 90 in., or at least 100 in. The first side piece 32 may have a length L_{SP1} that may be no greater than 150 in., no greater than 140 in., no greater than 130 in., no greater than 120 in., no greater than 110 in., or no greater than 105 in. In a more specific embodiment, the first side piece 32 may have a length L_{SP1} in a range of between about 80 in. to about 82 in.

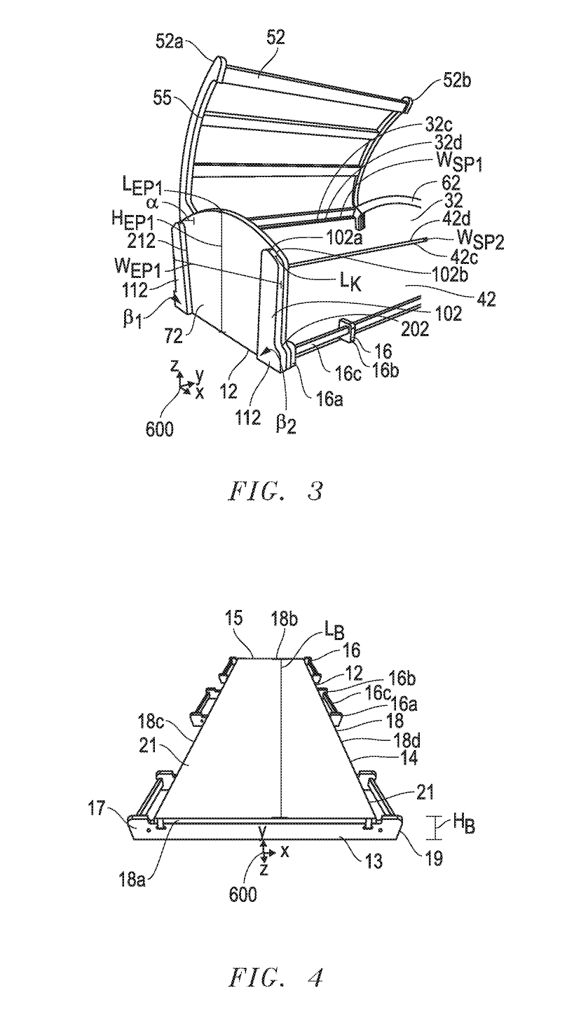

In a number of embodiments, as shown in FIG. 3, the first side piece 32 may have a width W_{SP1} as measured between a first latitudinal side 32c and a second latitudinal side 32d. The first side piece 32 may have a width W_{SP1} of at least ⅛ in., at least ¼ in., at least ⅓ in., at least ½ in, at least ⅔ in, at least 1 in, at least 2 in. The first side piece 32 may have a width W_{SP1} that may be no greater than 3 in., no greater than 2.5 in, no greater than 2 in., no greater than 1.75 in, no greater than 1.5 in. In a more specific embodiment, the first side piece 32 may have a width W_{SP1} in a range of between about ½ in. and about 1.5 in.

In a number of embodiments, as shown in FIG. 7, the first side piece 32 may have a height H_{SP1} as measured between its first vertical side (top) 32f and its second vertical side (bottom) 32e. The first side piece 32 may have a height H_{SP1} of at least at least 5 in., at least 7 in., at least 9 in., at least 11 in., at least 13 in., or at least 15 in. The first side piece 32 may have a height H_{SP1} that may be no greater than 30 in., no greater than 25 in., no greater than 20 in., no greater than 15 in., no greater than 12 in., or no greater than 10 in. In a more specific embodiment, the first side piece 32 may have a height H_{SP1} in a range of between about 8 in. to about 11 in.

### Attachment Flange

Referring to FIGS. 7-8 and 24, in a number of embodiments, the first side piece 32 may include at least one attachment flange 34 located on its second vertical side 32f. The attachment flange 34 may be placed within a flange cut 35 located on the second vertical side 32d of the first side piece 32. The attachment flange 34 may be adhered to a face 33 of the first side piece 32. The attachment flange 34 may have first and second latitudinal ends 34c, 34d. The attachment flange 34 may have first and second longitudinal ends 34a, 34b. The attachment flange 34 may have first and second vertical sides 34e, 34f. In a number of embodiments, the first side piece 32 may include a plurality of attachment flanges 34 located on its first vertical side 32c. In a number of embodiments, the attachment flange 34 may include at least one projection 36. In a number of embodiments, the attachment flange 34 may include a first projection 36a and a second projection 36b. In a number of embodiments, the first projection 36a may be oriented in a first longitudinal direction while the second projection 36b may be oriented in a second longitudinal direction opposite the first longitudinal direction. In a number of embodiments, the at least one attachment flange 34 may be a wood piece or a combination of several wood pieces attached together. In a number of embodiments, the at least one attachment flange 34 may be a wood piece integral with the first side piece 32. In a number of embodiments, the at least one attachment flange 34 may be a wood piece attached to the first side piece 32 through a fastening means. In a number of embodiments, the attachment flange 34 may include at least one attachment flange groove 31. In a number of embodiments, the attachment flange 34 may include a plurality of attachment flange grooves 31. In a number of embodiments, the attachment flange 34 may attach to the first side piece 32 through at least one attachment flange groove 31.

In a number of embodiments, as shown in FIG. 7, the attachment flange 34 may have a length L_{AF} as measured between a first longitudinal end 34a and a second longitudinal end 34b. The attachment flange 34 may have a length L_{AF} of at least ⅛ in., at least ¼ in., at least ⅓ in., at least ½ in, at least ⅔ in, at least 1 in, at least 2 in. The attachment flange 34 may have a length L_{AF} that may be no greater than 3 in., no greater than 2.5 in, no greater than 2 in., no greater than 1.75 in, no greater than 1.5 in. In a more specific embodiment, the attachment flange 34 may have a length L_{AF in} a range of between about ½ in. and about 1.5 in.

In a number of embodiments, as shown in FIG. 3, the attachment flange 34 may have a width W_{AF} as measured between a first latitudinal side 34c and a second latitudinal side 34d. The attachment flange 34 may have a width W_{AF} of at least ⅛ in., at least ¼ in., at least ⅓ in., at least ½ in, at least ⅔ in, at least 1 in, at least 2 in. The attachment flange 34 may have a width W_{AF} that may be no greater than 3 in., no greater than 2.5 in, no greater than 2 in., no greater than 1.75 in, no greater than 1.5 in. In a more specific embodiment, the attachment flange 34 may have a width W_{AF in} a range of between about ½ in. and about 1.5 in.

In a number of embodiments, as shown in FIG. 7, the attachment flange 34 may have a height H_{AF} as measured between its first vertical side (top) 34f and its second vertical side (bottom) 34e. The attachment flange 34 may have a height H_{AF} of at least at least 2 in., at least 5 in., at least 7 in., at least 10 in., at least 15 in., or at least 20 in. The attachment flange 34 may have a height H_{AF} that may be no greater than 40 in., no greater than 35 in., no greater than 30 in., no greater than 25 in., no greater than 20 in., or no greater than 15 in. In a more specific embodiment, the attachment flange 34 may have a height H_{AF} in a range of between about 10 in to about 15 in.

### Second Side Piece

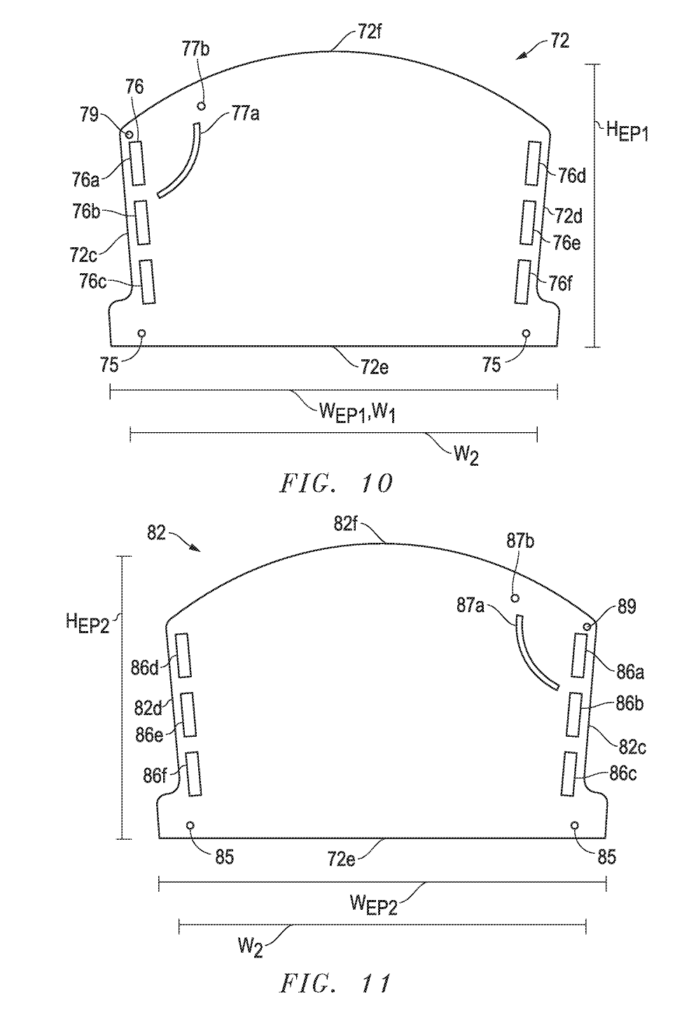

Referring to FIG. 9, in a number of embodiments, the casket 2 or kit 300 may include a second side piece 42. The second side piece 42 may have first and second longitudinal ends 42a, 42b. The second side piece 42 may have first and second latitudinal ends 42c, 42d. The second side piece 42 may have first and second vertical sides 42e, 42f. In a number of embodiments, the second side piece 42 may include at least one groove cut 43 located on its first vertical side 42e. The groove cut 43 may have a height H_{G2} of about ⅛, ¼, ⅓, ½ of the height H_{SP2} of the second side piece 42, or may be another ratio. In a number of embodiments, the second side piece 42 may include at least one trough cut or top edge groove 45 located on its second vertical side 42f. The trough cut 45 may have a height H_{G2} of about ⅛, ¼, ⅓, ½ of the height H_{SP2} of the second side piece 42, or may be another ratio. In a number of embodiments, the second side piece 42 may further include at least one hook attachment 48a on its first longitudinal end 42a. In a number of embodiments, the second side piece 42 may further include a plurality of hook attachments 48a on its first longitudinal end 42a. In a number of embodiments, the second side piece 42 may further include at least one hook attachment 48b on its second longitudinal end 42b. In a number of embodiments, the second side piece 42 may further include a plurality of hook attachments 48b on its second longitudinal end 42b. The hook attachment 48a, 48b may be a butt, an overlap, a bridle, a dowel, a mitre, a finger, a dovetail, a dado, a groove, a tongue, a tenon, a birdsmouth, a cross lap, a splice, a biscuit, a pocket-hole, a floating tenon, a stitch, a domino, or may be another type. In a number of embodiments, the hook attachment 48a, 48b may include a U-shape 47 with a top groove 49a formed interior to the U-shape 47, and a bottom groove 49b formed underneath the U-shape 47. An alternative embodiment of the hook attachment 48a, 48b is substantially similar to the hook attachment 38a shown in FIG. 28. In a number of embodiments, the second side piece 42 may be a wood board or assembly of wood pieces.

In a number of embodiments, as shown in FIG. 9, the second side piece 42 may have a length L_{SP2}as measured between a first longitudinal end 42a and a second longitudinal end 42b. The second side piece 42 may have a length L_{SP2} of at least 50 in., at least 60 in., at least 70 in., at least 80 in., at least 90 in., or at least 100 in. The second side piece 42 may have a length L_{SP2} that may be no greater than 150 in., no greater than 140 in., no greater than 130 in., no greater than 120 in., no greater than 110 in., or no greater than 105 in. In a more specific embodiment, the second side piece 42 may have a length L_{SP2} in a range of between about 80 in. to about 82 in.

In a number of embodiments, as shown in FIG. 3, the second side piece 42 may have a width W_{SP2} as measured between a first latitudinal side 42c and a second latitudinal side 42d. The second side piece 42 may have a width W_{SP2} of at least ⅛ in., at least ¼ in., at least ⅓ in., at least ½ in, at least ⅔ in, at least 1 in, at least 2 in. The second side piece 42 may have a width W_{SP2} that may be no greater than 3 in., no greater than 2.5 in, no greater than 2 in., no greater than 1.75 in, no greater than 1.5 in. In a more specific embodiment, the second side piece 42 may have a width W_{SP2} in a range of between about ½ in. and about 1.5 in.

In a number of embodiments, as shown in FIG. 9, the second side piece 42 may have a height H_{SP2} as measured between its first vertical side (top) 42f and its second vertical side (bottom) 42e. The second side piece 42 may have a height H_{SP2} of at least at least 5 in., at least 7 in., at least 9 in., at least 11 in., at least 13 in., or at least 15 in. The second side piece 42 may have a height H_{SP2} that may be no greater than 30 in., no greater than 25 in., no greater than 20 in., no greater than 15 in., no greater than 12 in., or no greater than 10 in. In a more specific embodiment, the second side piece 42 may have a height H_{SP2} in a range of between about 8 in. to about 11 in.

### First End Piece

Referring to FIG. 10, in a number of embodiments, the casket 2 or kit 300 may include at least one end piece. In a number of embodiments, the casket 2 or kit 300 may include a first end piece 72. The first end piece 72 may have first and second longitudinal ends 72a, 72b. The first end piece 72 may have first and second latitudinal ends 72c, 72d. The first end piece 72 may have first and second vertical sides 72e, 72f. In a number of embodiments, the first end piece 72 may include at least one aperture 76. The aperture 76 may have a round, oval, non-round, or polygonal cross-section. The aperture 76 may have a rectangular cross-section as shown. In a number of embodiments, the first end piece 72 may include a plurality of apertures 76a, 76b, 76c, 76d, 76e, 76f. In a number of embodiments, the apertures 76a, 76b, 76c may be oriented along the first latitudinal end 72c while the apertures 76d, 76e, 76f may be oriented along the second latitudinal end 72d. In a number of embodiments, the first end piece 72 may include a track aperture, groove, or projection 77a. The track aperture, groove, or projection 77a may form a semicircular path as shown. In a number of embodiments, the first end piece 72 may include a lock aperture, groove, or projection 77b. In a number of embodiments, the first end piece 72 may include a pivot aperture, groove, or projection 79. The pivot aperture, groove, or projection 79 may have a round, oval, non-round, or polygonal cross-section. In a number of embodiments, the first end piece 72 may include at least one dowel hole 75. In a number of embodiments, the first end piece 72 may be a wood board or assembly of wood pieces.

In a number of embodiments, as shown in FIG. 2, the first end piece 72 may have a length L_{EP1} as measured between a first longitudinal end 72a and a second longitudinal end 72b. The first end piece 72 may have a length L_{EP1} of at least ⅛ in., at least ¼ in., at least ⅓ in., at least ½ in, at least ⅔ in, at least 1 in, at least 2 in. The first end piece 72 may have a length L_{EP1} that may be no greater than 3 in., no greater than 2.5 in, no greater than 2 in., no greater than 1.75 in, no greater than 1.5 in. In a more specific embodiment, first end piece 72 may have a length L_{EP1} in a range of between about ½ in. and about 1.5 in.

In a number of embodiments, as shown in FIG. 10, the first end piece 72 may have a width W_{EP1} as measured between a first latitudinal side 72c and a second latitudinal side 72d. The first end piece 72 may have a width W_{EP1} of at least at least 10 in., at least 15 in., at least 20 in., at least 25 in., at least 30 in., or at least 35 in. The first end piece 72 may have a width W_{EP1} that may be no greater than 60 in., no greater than 55 in., no greater than 50 in., no greater than 45 in., no greater than 40 in., or no greater than 35 in. In a more specific embodiment, the first end piece 72 may have a width W_{EP1} in a range of between about 30 in. to about 32 in.

In a number of embodiments, as shown in FIG. 10, the first end piece 72 may have a height H_{EP1} as measured between its first vertical side (top) 72f and its second vertical side (bottom) 72e. The first end piece 72 may have a height H_{EP1} of at least 5 in., at least 7 in., at least 9 in., at least 11 in., at least 13 in., or at least 15 in. The first end piece 72 may have a height H_{EP1} that may be no greater than 30 in., no greater than 25 in., no greater than 20 in., no greater than 15 in., no greater than 12 in., or no greater than 10 in. In a more specific embodiment, the first end piece 72 may have a height H_{\EP1} in a range of between about 8 in. to about 11 in.

### Second End Piece

Referring to FIG. 11, in a number of embodiments, the casket 2 or kit 300 may include at least one end piece. In a number of embodiments, the casket 2 or kit 300 may include a second end piece 82. The second end piece 82 may have first and second longitudinal ends 82a, 82b. The second end piece 82 may have first and second latitudinal ends 82c, 82d. The second end piece 82 may have first and second vertical sides 82e, 82f. In a number of embodiments, the second end piece 82 may include at least one aperture 86. The aperture 86 may have a round, oval, non-round, or polygonal cross-section. The aperture 86 may have a rectangular cross-section as shown. In a number of embodiments, the second end piece 82 may include a plurality of apertures 86a, 86b, 86c, 86d, 86e, 86f. In a number of embodiments, the apertures 86a, 86b, 86c may be oriented along the first latitudinal end 82c while the apertures 86d, 86e, 86f may be oriented along the second latitudinal end 82d. In a number of embodiments, the second end piece 82 may include a track aperture, groove, or projection 87a. The track aperture, groove, or projection 87a may form a semicircular path as shown. In a number of embodiments, the second end piece 82 may include a lock aperture, groove, or projection 87b. In a number of embodiments, the second end piece 82 may include a pivot aperture, groove, or projection 89. The pivot aperture, groove, or projection 89 may have a round, oval, non-round, or polygonal cross-section. In a number of embodiments, the second end piece 82 may include at least one dowel hole 85. In a number of embodiments, the second end piece 82 may be a wood board or assembly of wood pieces.

In a number of embodiments, as shown in FIG. 2, the second end piece 82 may have a length L_{EP2} as measured between a first longitudinal end 82a and a second longitudinal end 82b. The second end piece 82 may have a length L_{EP2} of at least ⅛ in., at least ¼ in., at least ⅓ in., at least ½ in, at least ⅔ in, at least 1 in, in, at least 2 in. The second end piece 82 may have a length L_{EP2} that may be no greater than 3 in., no greater than 2.5 in, no greater than 2 in., no greater than 1.75 in, no greater than 1.5 in. In a more specific embodiment, second end piece 82 may have a length L_{EP2} in a range of between about ½ in. and about 1.5 in.

In a number of embodiments, as shown in FIG. 11, the second end piece 82 may have a width W_{EP2} as measured between a first latitudinal side 82c and a second latitudinal side 82d. The second end piece 82 may have a width W_{EP2} of at least at least 10 in., at least 15 in., at least 20 in., at least 25 in., at least 30 in., or at least 35 in. The second end piece 82 may have a width W_{EP2} that may be no greater than 60 in., no greater than 55 in., no greater than 50 in., no greater than 45 in., no greater than 40 in., or no greater than 35 in. In a more specific embodiment, the second end piece 82 may have a width W_{EP2} in a range of between about 30 in. to about 32 in.

In a number of embodiments, as shown in FIG. 11, the second end piece 82 may have a height H_{EP2} as measured between its first vertical side (top) 72f and its second vertical side (bottom) 72e. The second end piece 82 may have a height H_{EP2} of at least 5 in., at least 7 in., at least 9 in., at least 11 in., at least 13 in., or at least 15 in. The second end piece 82 may have a height H_{EP2} that may be no greater than 30 in., no greater than 25 in., no greater than 20 in., no greater than 15 in., no greater than 12 in., or no greater than 10 in. In a more specific embodiment, the second end piece 82 may have a height H_{EP2} in a range of between about 8 in. to about 11 in. In a number of embodiments, the first end piece 72 and the second end piece 82 may be substantially identical pieces.

### First Lid Piece

Referring to FIGS. 1-3 and 12-13, in a number of embodiments, the casket 2 or kit 300 may include at least one lid piece. In a number of embodiments, the casket 2 or kit 300 may include a first lid piece 52. The first lid piece 52 may have first and second longitudinal ends 52a, 52b. The first lid piece 52 may have first and second latitudinal ends 52c, 52d. The first lid piece 52 may have first and second vertical sides 52e, 52f. In a number of embodiments, the second vertical side 52f may be flat to form a planar section. In a number of embodiments, the second vertical side 52f may be rounded to form an arc or arcuate section. In a number of embodiments, the first vertical side 52e may include a plurality of internal ribs 55 for support or aesthetic value (as shown partially in FIG. 25 (similar to the second piece 62 with internal ribs 65). In a number of embodiments, the first vertical side 52e may be flat to form a planar section. In a number of embodiments, the first vertical side 52e may be rounded to form an arc or arcuate section. In a number of embodiments, the first lid piece 52 may include a vertical flange 54. In a number of embodiments, the first lid piece 52 may include a plurality of rotational apertures, grooves, or projections 56a, 56b, 56c. In a number of embodiments, the plurality of rotational apertures, grooves, or projections 56a, 56b, 56c may be located on the vertical flange 54. In a number of embodiments, the vertical flange 54 may be hemispherical or semi-hemispherical as shown in FIG. 21, by non-limiting example. The rotational apertures, grooves, or projections 56a, 56b, 56c may couple to at least one of the track aperture, groove, or projection 77a of the first end piece 72, the lock aperture, groove, or projection 77b of the first end piece 72, or the pivot aperture, groove, or projection 79 of the first end piece 72. In a number of embodiments, the first lid piece 52 may include at least one attachment flange 34 rotational aperture, groove, or projection 59 which may couple to a first projection 36a of the attachment flange 34. Dowels may be used to couple any of these components to provide the first lid piece 52 the ability to pivot or rotate, providing an open casket 2 as shown in FIG. 3. A dowel placed in the lock aperture 77b may lock the first lid piece 52 in an open position. In a number of embodiments, the first lid piece 52 may form a first lid piece angle a with the latitudinal direction, wherein the first lid piece angle a may be at least 15°, at least 30°, at least 45°, at least 60°, at least 75°, or at least 90°. In an alternative embodiment, as shown in FIG. 21, the first lid piece 52 may be coupled to the second lid piece 62, such as by a dowel 117 placed between the two lid pieces. In such an embodiment, one of the first lid piece 52 or the second lid piece 62 may be fixed and used as a rotational pivot for the other of the of the first lid piece 52 or the second lid piece 62. This embodiment, where the first lid piece and the second lid piece are coupled together, can be a replacement for, or a compliment to, an attachment flange 34. Thus, in certain embodiments, attachment flange 34 need not be included in the casket 2 or kit 300. In a number of embodiments, the first lid piece 52 may be a wood board or assembly of wood pieces.

In a number of embodiments, as shown in FIG. 2, the first lid piece 52 may have a length L_{LP1} as measured between a first longitudinal end 52a and a second longitudinal end 52b. The first lid piece 52 may have a length L_{LP1} of at least 25 in., at least 30 in., at least 35 in., at least 40 in., at least 50 in., or at least 60 in. The first lid piece 52 may have a length L_{LP1} that may be no greater than 75 in., no greater than 60 in., no greater than 65 in., no greater than 60 in., no greater than 55 in., or no greater than 50 in. In a more specific embodiment, the first lid piece 52 may have a length L_{LP1} in a range of between about 38 in. to about 42 in.

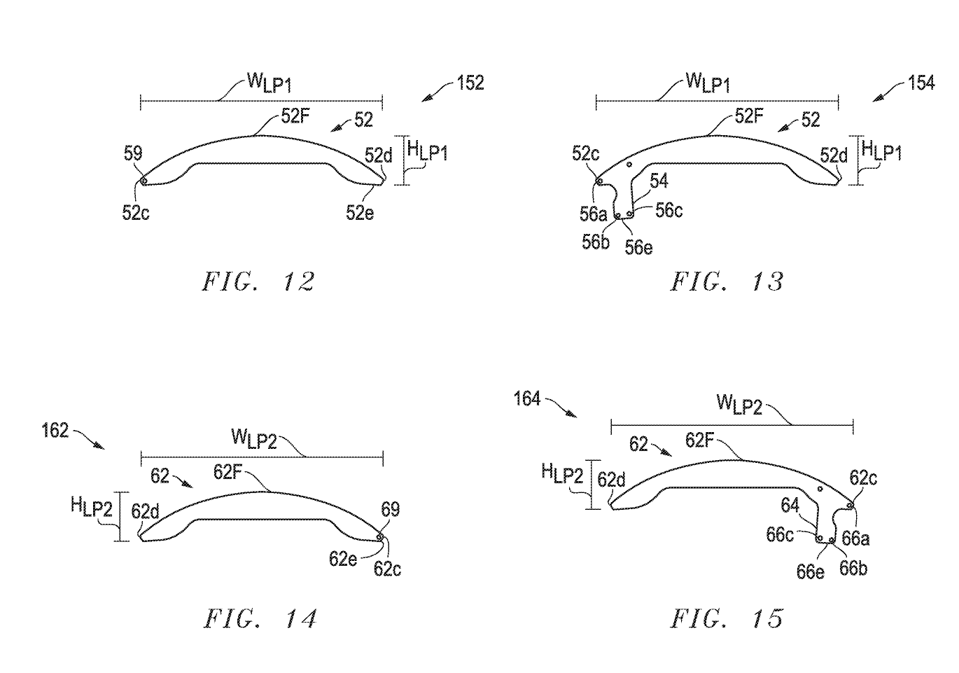

In a number of embodiments, as shown in FIGS. 12-13, the first lid piece 52 may have a width W _{LP1} as measured between a first latitudinal side 52c and a second latitudinal side 52d. The first lid piece 52 may have a width W_{LP1} of at least 10 in., at least 15 in., at least 20 in., at least 25 in., at least 30 in., or at least 35 in. The first lid piece 52 may have a width W_{LP1} that may be no greater than 60 in., no greater than 55 in., no greater than 50 in., no greater than 45 in., no greater than 40 in., or no greater than 35 in. In a more specific embodiment, the first lid piece 52 may have a width W _{LP1} in a range of between about 30 in. to about 32 in.

In a number of embodiments, as shown in FIGS. 12-13, the first lid piece 52 may have a height H_{LP1} as measured between its first vertical side 52e and its second vertical side 52f. The first lid piece 52 may have a height H_{LP1} of at least 0.5 in., at least 2 in., at least 4 in., at least 6 in., at least 8 in., or at least 10 in. The first lid piece 52 may have a height H_{LP1} that may be no greater than 30 in., no greater than 25 in., no greater than 20 in., no greater than 15 in., no greater than 12 in., or no greater than 10 in. In a more specific embodiment, the first lid piece 52 may have a height H_{LP1} in a range of between about 1.5 in. to about 3 in.

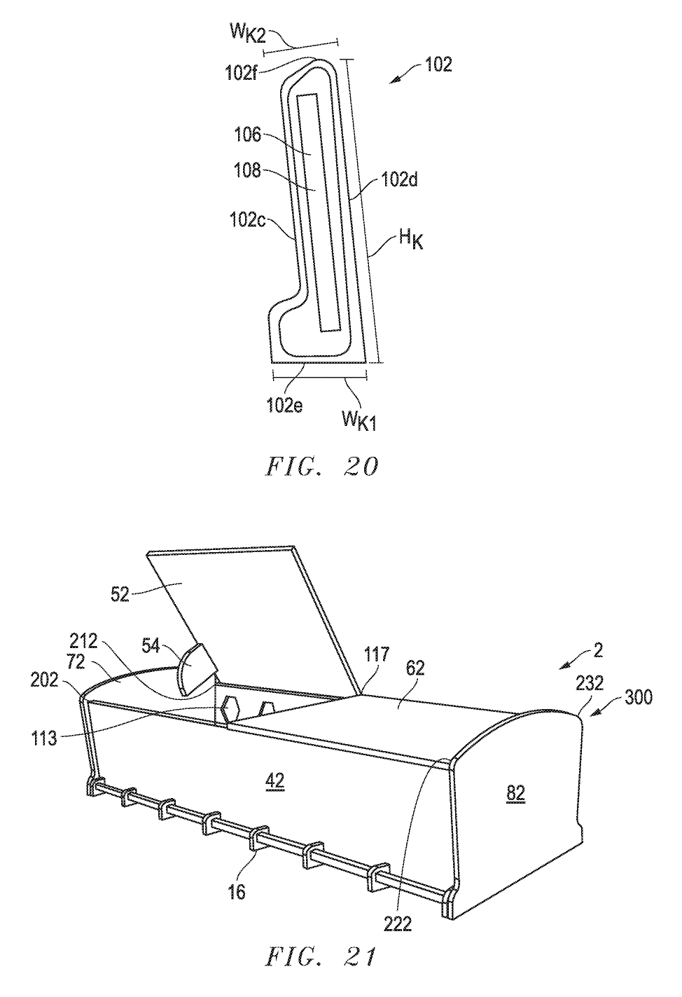

In a number of embodiments, as shown in FIGS. 12-13, the first lid piece 52 may include a first lid piece first end side 152 and a first lid piece second end side 154. The first lid piece first end side 152 and a first lid piece second end side 154 may be situated at the first longitudinal end 52a and the second longitudinal end 52b respectively, or may be vice versa. As shown in FIG. 18, first lid piece 52 may have a plurality of lid piece top pieces 156, 156′ longitudinally therebetween the first lid piece first end side 152 and the first lid piece second end side 154 on the second vertical side 52f. These pieces may be substantially flat as shown in FIG. 19, or shaped (including arcuate or hemispherical) as shown in FIG. 18. The first lid piece 52 may further include a first lid piece ridge 158 that runs longitudinally between two lid piece top pieces 156, 156′. In a number of embodiments, the first lid piece 52 may be flat, as shown in FIG. 19. In this embodiment, the lid ribs 55 may be removed and a lid bracket 111 may be used.

### Second Lid Piece

Referring to FIGS. 1-3 and 14-15, in a number of embodiments, the casket 2 or kit 300 may include at least one lid piece. In a number of embodiments, the casket 2 or kit 300 may include a second lid piece 62. The second lid piece 62 may have first and second longitudinal ends 62a, 62b. The second lid piece 62 may have first and second latitudinal ends 62c, 62d. The second lid piece 62 may have first and second vertical sides 62e, 62f. In a number of embodiments, the second vertical side 62f may be flat to form a planar section. In a number of embodiments, the second vertical side 62f may be rounded to form an arc or arcuate section. In a number of embodiments, the first vertical side 62e may include a plurality of internal ribs 65 for support or aesthetic value, as shown in FIG. 25. In a number of embodiments, the first vertical side 62e may be flat to form a planar section. In a number of embodiments, the first vertical side 62e may be rounded to form an arc or arcuate section. In a number of embodiments, the second lid piece 62 may include a vertical flange 64. In a number of embodiments, the second lid piece 62 may include at least one rotational aperture, groove, or projection 66. In a number of embodiments, the second lid piece 62 may include a plurality of rotational apertures, grooves, or projections 66a, 66b, 66c. In a number of embodiments, the plurality of rotational apertures, grooves, or projections 66a, 66b, 66c may be located on the vertical flange 64. In a number of embodiments, the vertical flange 64 may be hemispherical or semi-hemispherical as shown in FIG. 21, by non-limiting example. The rotational apertures, grooves, or projections 66a, 66b, 66c may couple to at least one of the track aperture, groove, or projection 87a of the second end piece 82, the lock aperture, groove, or projection 87b of the second end piece 82, or the 89 pivot aperture, groove, or projection 89 of the second end piece 82. In a number of embodiments, the second lid piece 62 may include at least one attachment flange rotational aperture, groove, or projection 69 which may couple to a second projection 36b of the attachment flange 34. Dowels may be used to couple any of these components to provide the second lid piece 62 the ability to pivot or rotate, providing an open casket 2 as shown in FIG. 3. A dowel placed in the lock aperture 87b may lock the second lid piece 62 in an open position. In a number of embodiments, the second lid piece 62 may form a second lid piece angle a with the latitudinal direction, wherein the second lid piece angle a may be at least 15°, at least 30°, at least 45°, at least 60°, at least 75°, or at least 90°. In an alternative embodiment, as shown in FIG. 21, the first lid piece 52 may be attached to the second lid piece 62 by a dowel 117 placed between the two lid pieces. In such an embodiment, one of the first lid piece 52 or the second lid piece 62 may be fixed and used as a rotational pivot for the other of the of the first lid piece 52 or the second lid piece 62. In this embodiment an attachment flange 34 may not be included in the casket 2 or kit 300. In a number of embodiments, the second lid piece 62 may be a wood board or assembly of wood pieces.

In a number of embodiments, as shown in FIG. 2, the second lid piece 62 may have a length L_{LP2} as measured between a first longitudinal end 62a and a second longitudinal end 62b. The second lid piece 62 may have a length L_{LP2} of at least 25 in., at least 30 in., at least 35 in., at least 40 in., at least 50 in., or at least 60 in. The second lid piece 62 may have a length L_{LP2} that may be no greater than 75 in., no greater than 60 in., no greater than 65 in., no greater than 60 in., no greater than 55 in., or no greater than 50 in. In a more specific embodiment, the second lid piece 62 may have a length L_{LP2} in a range of between about 38 in. to about 42 in.

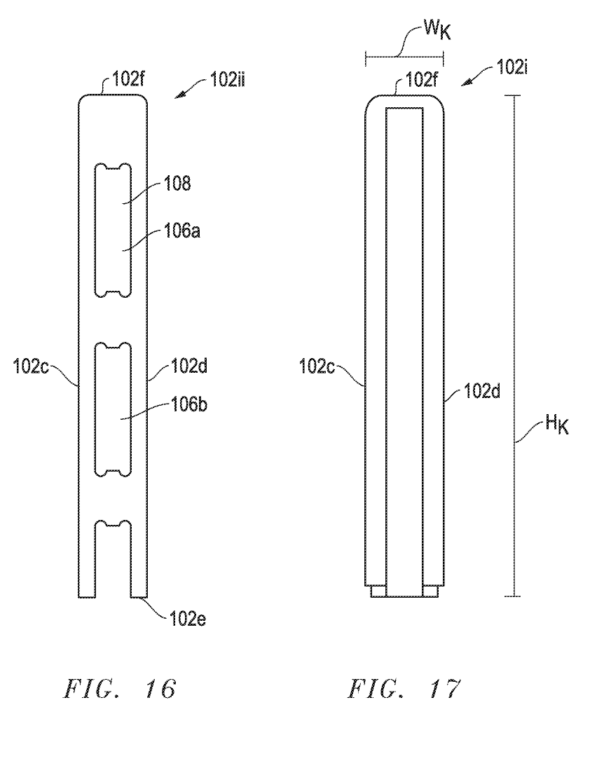

In a number of embodiments, as shown in FIGS. 14-15, the second lid piece 62 may have a width W_{LP2} as measured between a first latitudinal side 62c and a second latitudinal side 62d. The second lid piece 62 may have a width W_{LP2} of at least 10 in., at least 15 in., at least 20 in., at least 25 in., at least 30 in., or at least 35 in. The second lid piece 62 may have a width W_{LP2} that may be no greater than 60 in., no greater than 55 in., no greater than 50 in., no greater than 45 in., no greater than 40 in., or no greater than 35 in. In a more specific embodiment, the second lid piece 62 may have a width W_{LP2} in a range of between about 30 in. to about 32 in.

In a number of embodiments, as shown in FIGS. 14-15, the second lid piece 62 may have a height H_{LP2} as measured between its first vertical side 62e and its second vertical side 62f. The second lid piece 62 may have a height H_{LP2} of at least 0.5 in., at least 2 in., at least 4 in., at least 6 in., at least 8 in., or at least 10 in. The second lid piece 62 may have a height H_{LP2} that may be no greater than 30 in., no greater than 25 in., no greater than 20 in., no greater than 15 in., no greater than 12 in., or no greater than 10 in. In a more specific embodiment, the second lid piece 62 may have a height H_{LP2} in a range of between about 1.5 in. to about 3 in.

In a number of embodiments, as shown in FIGS. 14-14, the second lid piece 62 may include a second lid piece first end side 162 and a second lid piece second end side 164. The second lid piece first end side 162 and a second lid piece second end side 164 may be situated at the first longitudinal end 62a and the second longitudinal end 62b respectively, or may be vice versa. Similarly to the first lid piece 52 embodiment shown in FIG. 18, second lid piece 62 may have a plurality of lid piece top pieces 166, 166′ longitudinally therebetween the second lid piece first end side 162 and the second lid piece second end side 164 on the second vertical side 62f. These pieces may be substantially flat as shown in FIG. 19, or shaped (including arcuate or hemispherical) as shown in FIG. 18. The second lid piece 62 may further include a second lid piece ridge 168 that runs longitudinally between two lid piece top pieces 166, 166′. In a number of embodiments, the second lid piece 52 may be flat, as shown in FIG. 19. In this embodiment, the lid ribs 65 may be removed and a lid bracket (not shown) may be used.

### Keeper

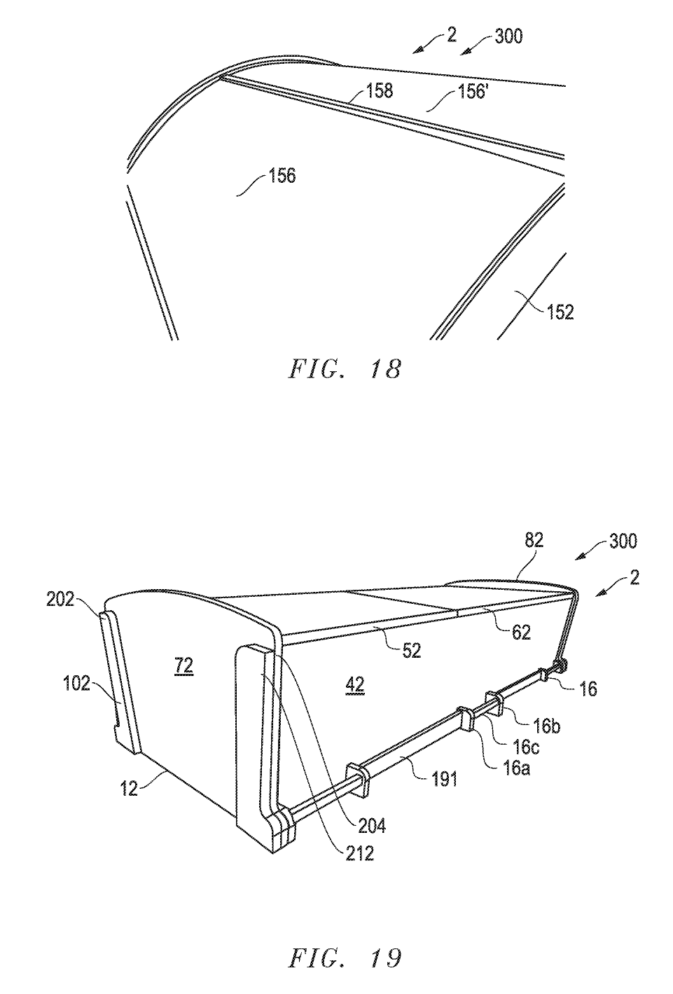

Referring to FIGS. 2-3 and 16-17, in a number of embodiments, the casket 2 or kit 300 may include at least one keeper. In a number of embodiments, the casket 2 or kit 300 may include a plurality of keepers 102, 112, 122, 132. In a number of embodiments, the keepers 102, 112, 122, 132 may be substantially similar. Using FIGS. 2-3, 16-17, and 19 as illustrative of all keepers 102, 112, 122, 132 using keeper 102 as exemplary, the keepers 102 may have first and second longitudinal ends 102a, 102b. The keepers 102 may have first and second latitudinal ends 102c, 102d. The keepers 102 may have first and second vertical sides 102e, 102f. In a number of embodiments, the keepers 102 may include a backing 102i (shown in FIG. 17) and an insert 102ii (shown in FIG. 16). In a number of embodiments, the insert 102ii fits within the backing 102i. The insert 102ii may be coupled to the exterior section 102i through any of the fastening means described above. In a number of embodiments, the insert 102ii may include at least one keeper aperture 106. In a number of embodiments, the insert 102ii may include a plurality of keeper apertures 106a, 106b. The keeper aperture 106 may have a round, oval, non-round, or polygonal cross-section. The aperture 106 may have a rounded H-shaped cross-section as shown. In a number of embodiments, the apertures 106a, 106b may be oriented from a first vertical direction 102e to a second vertical direction 102f. In a number of embodiments, the keeper 102 insert 102ii may pair with the backing 102i to provide a locking void 108. In a number of embodiments, the keeper 102 may be a wood board or assembly of wood pieces. In a number of embodiments, the keeper 102 may span the entire width of the casket 2.

In a number of embodiments, as shown in FIG. 3, the keeper 102 (or any one of the plurality of keepers 112, 122, 132) may have a length L_{K} as measured between a first longitudinal end 102a and a second longitudinal end 102b. The keeper 102 may have a length L_{K} of at least ⅛ in., at least ¼ in., at least ⅓ in., at least ½ in, at least ⅔ in, at least 1 in, at least 2 in. The keeper 102 may have a length L_{K} that may be no greater than 3 in., no greater than 2.5 in, no greater than 2 in., no greater than 1.75 in, no greater than 1.5 in. In a more specific embodiment, the keeper 102 may have a length L_{K} in a range of between about ½ in. and about 1.5 in.

In a number of embodiments, as shown in FIG. 11, the keeper 102 (or any one of the plurality of keepers 112, 122, 132) may have a width W_{K} as measured between a first latitudinal side 102c and a second latitudinal side 102d. The keeper 102 may have a width W_{K} of at least at least ⅛ in., at least ¼ in., at least ⅓ in., at least ½ in, at least ⅔ in, at least 1 in, at least 2 in. The keeper 102 may have a width W_{K} that may be no greater than no greater than 3 in., no greater than 2.5 in, no greater than 2 in., no greater than 1.75 in, no greater than 1.5 in. In a more specific embodiment, the keeper 102 may have a width W_{K} in a range of between about ½ in. and about 1.5 in. In another specific embodiment, the keeper 102 may have a width W_{K} in a range of between about 18 in. and about 45 in.

In a number of embodiments, as shown in FIG. 11, the keeper 102 (or any one of the plurality of keepers 112, 122, 132) may have a height H_{K} as measured between its first vertical side 102f and its second vertical side 102e. The keeper 102 may have a height H_{K} of at least 5 in., at least 7 in., at least 9 in., at least 11 in., at least 13 in., or at least 15 in. The keeper 102 may have a height H_{K} that may be no greater than 30 in., no greater than 25 in., no greater than 20 in., no greater than 15 in., no greater than 12 in., or no greater than 10 in. In a more specific embodiment, the keeper 102 may have a height H_{K} in a range of between about 8 in. to about 11 in.

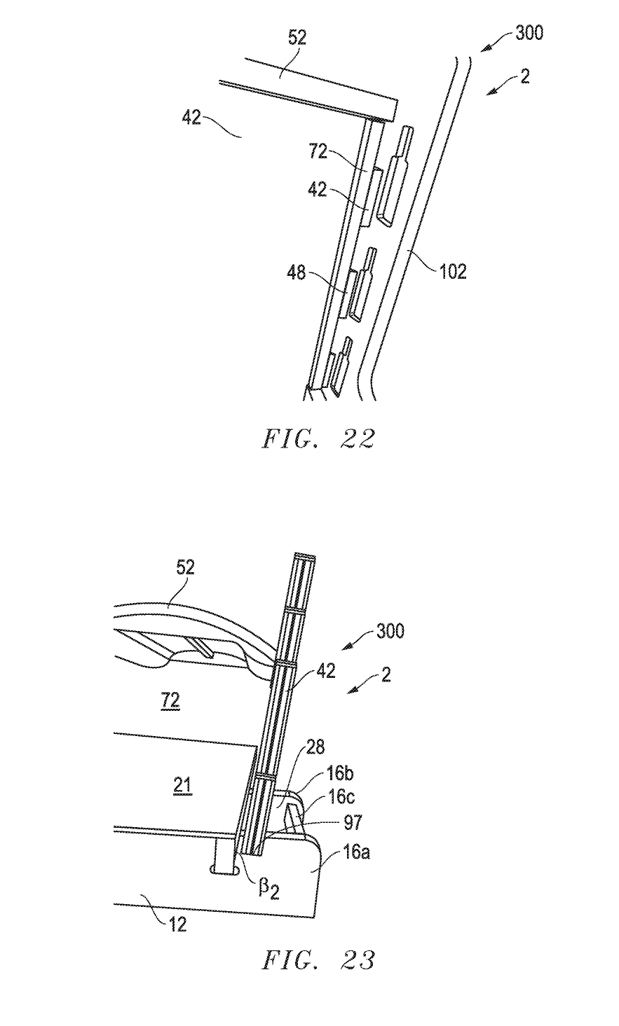

In an alternative embodiment, as shown in FIG. 20, the keeper 102 (or any one of the plurality of keepers 112, 122, 132) may have a single aperture 106 with a locking void 108. In this alternative embodiment, the keeper 102 may have a wider width W_{K1} at the base than at the top W_{K2} as shown. FIG. 19 shows keepers 102, 112 in use. In a number of embodiments, a keeper 102 may cover substantially the first end piece 72 (as shown in FIG. 22), with a second keeper 112 covering substantially the second end piece 82. In a number of embodiments, as shown in FIGS. 22 and 28, the keeper 102 may have a bottle-shaped opening 106 with a locking void 108 that may slide and lock the hook attachment 48 of the second side piece 42 to form a first coupling 202 (or other couplings 212, 222, 232). In another embodiment, as shown in FIG. 29, the keeper may include a squared opening 106 with rounded edges forming the locking void 108.

In still another embodiment, at least one of the apertures 106 and locking voids 108 of the keeper 102 (or any one of the plurality of keepers 112, 122, 132) may instead be incorporated into the faces of end pieces 72, 82 themselves as shown by example in FIG. 28. In this embodiment, keepers 102,112 may be the same piece as the first end piece 72 while keepers 122, 132 may be the same piece as the second end piece 82. In other words, the keeper pieces 102, 112, 122, 132 may be eliminated with their function incorporated into the first end piece 72 and the second end piece 82, as shown best in FIGS. 21-22 and 28 where the apertures 106 and locking voids 108 are disposed in the first end piece 72 and second end piece 82 as shown. The apertures 106 and locking voids 108 may have any orientation described for the keepers (as shown in FIGS. 16-17, 20, 22, 28, and 29). The end pieces 72, 82 may slide and lock the hook attachments 38, 48 of the first and second side pieces 32, 42 to form a first coupling 202 (or other couplings 212, 222, 232). The apertures 106 and locking voids 108 in the end pieces 72, 82 may be multiple aperture (as shown in FIGS. 16 and 17), single aperture (as shown in FIG. 20), bottleneck (as shown in FIGS. 22 and 28), or squared opening with rounded edges (as shown in FIG. 29). In this embodiment, the apertures of the first end piece 72, (76a, 76b, 76c, 76d, 76e, 760, and the apertures of the second end piece 82 (86a, 86b, 86c, 86d, 86e, 86f) may be replaced by apertures 106 and locking voids 108 as shown.

### Assembly Example

In a number of embodiments, a casket 2 or kit 300 may be assembled from what is shown in FIG. 1 to what is shown in FIG. 2 using a method as follows. First, the base 12 may be provided on an assembly surface as shown in FIG. 4. The base 12 may include a base main body 14 and at least one base handle 16.

Next, a first side piece 32 may be provided within a void 28 between the base main body 14 and at least one of the base handle 16 through the groove cuts 33 in the first side piece 32 coupling with the first longitudinal end piece 16a or second longitudinal end piece 16b of the handle 16. This may allow the first side piece 32 to abut the base main body 14 and tilt outward until catching the at least one base handle 16 at the connection portion 16c as shown in FIG. 3. In this way, the first side piece 32 may form an angle β₁ with the vertical z direction. The angle β₁ may be at least 2°, at least 5°, at least 7°, at least 9°, or at least 12° similar to the embodiment for the second side piece 42 shown in FIG. 23. In a number of embodiments, the first side piece 32 may include at least one hook attachment 38 at an end of the first side piece 32. In a number of embodiments, the first side piece 32 may include at least one hook attachment 38a at a first end of the first side piece 32 and at least one hook attachment 38b at a second end of the first side piece 32 longitudinally opposite the first end. In a number of embodiments, the first side piece 32 may include an attachment flange 34 located on a top of the first side piece 32. The attachment flange 34 may include at least one projection 36. In a number of embodiments, the attachment flange 34 may form at least two projections 36a, 36b.

Next, a second side piece 42 may be provided within a void 28 between the base main body 14 and at least one of the base handle 16 through the groove cuts 43 in the a second side piece 42 coupling with the first longitudinal end piece 16a or second longitudinal end piece 16b of the handle 16 on the opposite longitudinal side of the base 12 from the first side piece 32. This may allow the second side piece 42 to abut the base main body 14 and tilt outward until catching the at least one base handle 16 at the connection portion 16c as shown in FIG. 3. In this way, the second side piece 42 may form an angle β₂ with the vertical z direction. The angle β₂ may be at least 2°, at least 5°, at least 7°, at least 9°, or at least 12°. In a number of embodiments, the second side piece 42 may include at least one hook attachment 48 at an end of the second side piece 42. In a number of embodiments, the second side piece 42 may include at least one hook attachment 48a at a first end of the second side piece 42 and at least one hook attachment 48b at a second end of the second side piece 42 longitudinally opposite the first end.

In this way, the casket 2 will have a different width at the base than at the top since the first side piece 32 and second side piece 42 tilt outward. In a number of embodiments, the base width W₁ and the top width W₂ of the casket 2 may be different from each other as shown best in FIG. 23. In a number of embodiments, the base width W₁ and the top width W₂ may form a ratio of W₂/W₁. The ratio of W₂/W₁ may be greater than 1, greater than 1.2, greater than 1.5, or greater than 2. The ratio of W₂/W₁ may be less than 2, less than 1.5, or less than 1. In this way, the casket 2 or kit may be packaged in a smaller size or packaged more efficiently while being able to support a larger corpse.

Next, at least one lid piece may be attached to a top of a first side piece 32. The at least one lid piece may rest on the top of the first side piece 32 and the top of the second side piece 34. In a number of embodiments, the at least one lid piece can include two lid pieces 52, 62. The first and second lid pieces 52, 62 may each rest on the top of the first side piece 32 and the top of the second side piece 42. In a number of embodiments, the at least one lid piece 52, 62 may contact the attachment flange 34 located on the top of the first side piece 32. In a number of embodiments, the first lid piece 52 may rotatably attach to the first projection 36a of the attachment flange 34. In a number of embodiments, the first lid piece 52 may rotatably attach to the first projection 36a of the attachment flange 34 through the first attachment flange rotational aperture, groove, or projection 59, while the second lid piece 62 may rotatably attach to the second projection 36b of the attachment flange 34 through the second attachment flange rotational aperture, groove, or projection 69.

Next, a first end piece 72 may be provided to contact and engage the at least one hook attachment 38a, 48a of the first side piece 32 and the second side piece 42 respectively through at least one aperture 74a, 74b, 74c, 74d, 74e, 74f formed in the face of the first end piece 72 to form a first coupling 202 and a second coupling 212 respectively. The couplings 202, 212 may each be a hook and groove joint with the hook attachments 38 of the side pieces 52, 62 going through pairing apertures 74 in the end piece 72. In a number of embodiments, the first lid piece 52 rotational grooves, or projections 56a, 56b, 56c may couple to at least one of the track aperture, groove, or projection 77a of the first end piece 72, the lock aperture, groove, or projection 77b of the first end piece 72, or the pivot aperture, groove, or projection 79 of the first end piece 72 to rotate along an axis defined by the plane of the top of the first side piece 32 in the longitudinal direction. This may provide a lid closing mechanism 250 with a groove 77a in an end piece 72 coupling a movable flange or projection 56a, 56b, 56c in a lid piece 52. The lid closing mechanism 250 may further include a protrusion joint

Next, a second end piece 82 may be provided to contact and engage the at least one hook attachment 38b, 48b of the first side piece 32 and the second side piece 42 respectively through at least one aperture 84a, 84b, 84c, 84d, 84e, 84f formed in the face of the second end piece 82 to form a third coupling 222 and a fourth coupling 232 respectively. The couplings 222, 232, may each be a hook and groove joint with the hook attachments 38 of the side pieces 52, 62 going through pairing apertures 84 in the end piece 82. In a number of embodiments, the second lid piece 62 rotational grooves, or projections 66a, 66b, 66c may couple to at least one of the track aperture, groove, or projection 87a of the second end piece 82, the lock aperture, groove, or projection 87b of the second end piece 82, or the pivot aperture, groove, or projection 89 of the second end piece 72 to rotate along an axis defined by the plane of the top of the first side piece 32 in the longitudinal direction. This may provide a lid closing mechanism 350 with a groove 87a in an end piece 782 coupling a movable flange or projection 66a, 66b, 66c in a lid piece 62. The lid closing mechanism 350 may further include a protrusion joint

Next, a first keeper 102 may be placed over the first coupling 202 of the hook attachment 38a of the first side piece 32 and the aperture 74a of the first end piece 72. Next, a second keeper 112 may be placed over the second coupling 212 of the hook attachment 38b of the first side piece 32 and the aperture 74b of the first end piece 72. Next, a third keeper 122 may be placed over the third coupling 222 of the hook attachment 48a of the second side piece 42 and the aperture 84a of second end piece 82. Next, a fourth keeper 132 may be placed over the fourth coupling 232 of the hook attachment 48b of the second side piece 42 and the aperture 84b of the second end piece 82. The keepers 102, 112, 122, 132 may be placed over the couplings 202, 212, 222, 232 in any order and may lock the side pieces 32, 42, and end pieces 72, 82 together, while locking all of these components to the base 12. The keepers 102, 112, 122, 132 may be placed over the couplings 202, 212, 222, 232 in any order and may lock the side pieces 32, 42, and end pieces 72, 82 together through a hook and groove joint between their respective hook attachments 38, 48, and apertures 74, 84. A casket 2 may be assembled in this way including the steps above in any order.

As an alternative to keepers 102, 11, 122, 132 as described above, the first end piece 72 may be provided to contact and engage the at least one hook attachment 38a, 48a of the first side piece 32 and the second side piece 42 respectively through at least one aperture 106 and locking void 108 formed in the face of the first end piece 72 to form a first coupling 202 and a second coupling 212 respectively. Next, the second end piece 82 may be provided to contact and engage the at least one hook attachment 38b, 48b of the first side piece 32 and the second side piece 42 respectively through at least one aperture 106 and locking void 108 formed in the face of the second end piece 82 to form a third coupling 222 and a fourth coupling 232 respectively to complete assembly of the casket 2.

In an embodiment, the casket 2 or kit 300 can be installed or assembled by an assembly force of at least 1 kgf in a longitudinal direction relative to the shaft 4 or housing 8, such as at least 2 kgf, at least 3 kgf, at least 4 kgf, at least 5 kgf, at least 10 kgf, or even at least 15 kgf. In a further embodiment, the casket 2 or kit 300 can be installed or assembled by an assembly force of no greater than 20 kg in a longitudinal direction to the housing 8, such as no greater than 19 kgf, no greater than 18 kgf, no greater than 17 kgf, or even no greater than 16 kgf. In an embodiment, the casket 2 or kit 300 can be disassembled by an disassembly force of at least 1 kgf in a longitudinal direction relative to the shaft 4 or housing 8, such as at least 2 kgf, at least 3 kgf, at least 4 kgf, at least 5 kgf, at least 10 kgf, or even at least 15 kgf. In a further embodiment, the casket 2 or kit 300 can be disassembled by a disassembly force of no greater than 20 kg in a longitudinal direction to the housing 8, such as no greater than 19 kgf, no greater than 18 kgf, no greater than 17 kgf, or even no greater than 16 kgf.

Many different aspects and embodiments are possible. Some of those aspects and embodiments are described below. After reading this specification, skilled artisans will appreciate that those aspects and embodiments are only illustrative and do not limit the scope of the present invention. Embodiments may be in accordance with any one or more of the embodiments as listed below.

Embodiment 1. A collapsible casket comprising: a hollow base comprising: a frame, and a plurality of internal intersecting members, wherein at least one intersecting member is disposed interior to the frame.

Embodiment 2. A collapsible casket comprising: a base; at least one lid piece; a plurality of side pieces; and a plurality of end pieces, wherein the base comprises a hollow base comprising a frame, and a plurality of internal intersecting members, wherein at least one intersecting member is disposed interior to the frame.

Embodiment 3. A kit for a collapsible casket comprising: a hollow base comprising: a frame, and a plurality of internal intersecting members, wherein at least one intersecting member is disposed interior to the frame; at least one lid piece; a plurality of sides pieces; and a plurality of end piece, wherein the kit is adapted to be packaged to fit within a maximum combined length and girth of 165 inches.

Embodiment 4. A collapsible casket or kit of any of embodiments 1, 2, or 3, wherein the wherein at least one intersecting member comprises a slot to interlock a pair of intersecting members together.

Embodiment 5. A collapsible casket or kit of any of embodiments 2 or 3, wherein at least one of the end pieces couples to at least one of the side pieces through a hook and groove joint.

Embodiment 6. A collapsible casket or kit of embodiment 5, further comprising a keeper adapted to lock the end piece to the side piece through the hook and groove joint.

Embodiment 7. A collapsible casket or kit of any of embodiments 1, 2, or 3, wherein the casket is assembled to form a base width W₁ and a top width W₂ and wherein the ratio of W₂/W₁ is greater than 1, greater than 1.2, greater than 1.5, or greater than 2.

Embodiment 8. A collapsible casket or kit of any of embodiments 1, 2, or 3, wherein the casket further includes a lid closing mechanism comprising a groove in an end piece coupled to a movable flange in a lid piece.

Embodiment 9. A collapsible casket or kit of any of embodiment 8, wherein the lid closing mechanism further comprises a lock aperture and a projection to lock the lid in a stationary position relative to the end piece.

Embodiment 10. A collapsible casket or kit of any of embodiments 1, 2, or 3, wherein the casket is substantially made out of wood.

Embodiment 11. A collapsible casket or kit of any of embodiments 2 or 3, wherein at least one lid piece has an arcuate shape comprising a plurality of internal ribs.

Embodiment 12. A collapsible casket or kit of any of embodiments 2 or 3, wherein at least one side piece has a top edge groove.

Embodiment 13. A collapsible casket or kit of any of embodiments 2 or 3, wherein the end piece has an arcuate top shape.

Embodiment 14. A collapsible casket or kit of any of embodiments 1, 2, or 3, wherein the base comprises at least one handle.

Embodiment 15: A collapsible casket or kit of any of embodiments 1, 2, or 3, wherein the casket has a length of between about 80 in. and about 82 in.

Embodiment 16. A collapsible casket or kit of any of embodiments 1, 2, or 3, wherein the casket has a height of between 8 in. to about 11 in.

Embodiment 17. A collapsible casket or kit of any of embodiments 1, 2, or 3, wherein the casket has a width of between 30 in. and about 32 in.

Embodiment 18. A collapsible casket or kit of any of embodiments 1, 2, or 3, wherein the frame comprises a plurality of sides and a plurality of ends.

Embodiment 19. A collapsible casket or kit of any of embodiments 1, 2, or 3, wherein the frame forms a rectangular shape.

Embodiment 20. A collapsible casket or kit of any of embodiments 1, 2, or 3, wherein the casket further comprises a fabric lining.

Embodiment 21. A collapsible casket comprising: a hollow base comprising a frame and a plurality of internal intersecting members disposed interior to the frame.

Embodiment 22. The collapsible casket of embodiment 21, wherein the plurality of intersecting members interlock.

Embodiment 23. The collapsible casket of embodiment 22, wherein at least one of the plurality of intersecting members comprises a slot cut into the at least one intersecting member to interlock the plurality of members together.

Embodiment 24. The collapsible casket of embodiment 21, wherein the internal intersecting members form a polygon, a cross shape, an octothorpe, or any combination thereof.

Embodiment 25. The collapsible casket of embodiment 21, wherein the internal intersecting members extend outward longitudinally, laterally, diagonally, or a combination thereof, from the center of the base as viewed from above the base.

Embodiment 26. The collapsible casket of embodiment 21, wherein the internal intersecting members extend inward from the sides of the frame toward the center of the base as viewed from above the base.

Embodiment 27. The collapsible casket of embodiment 21, wherein the frame comprises at least two latitudinal pieces and at least two longitudinal pieces that interlock to form a rectangle.

Embodiment 28. The collapsible casket of embodiment 27, wherein the frame comprises a plurality of handles.

Embodiment 29. The collapsible casket of embodiment 28, wherein each handle comprises two lateral pieces positioned in parallel that are disposed to intersect across and with the two longitudinal pieces.

Embodiment 30. The collapsible casket of embodiment 29, wherein the handle further comprises a hand grip coupled to and disposed between the two lateral pieces at the distal ends of the lateral pieces.

Embodiment 31. The collapsible casket of embodiment 1 further comprising: a lid; a plurality of side pieces; and a plurality of end pieces, wherein the side pieces and the end pieces are coupled to each other and coupled to the base to form a polygonal shaped box.

Embodiment 32. The collapsible casket of embodiment 31, wherein at least one of the end pieces couples to at least one of the side pieces through a modified mortise and tenon joint, a hook and groove joint, or a combination thereof.

Embodiment 33. The collapsible casket of embodiment 31, wherein one of the end pieces comprises an arcuate top shape.

Embodiment 34. The collapsible casket of embodiment 31, wherein the lid comprises a plurality of lid pieces.

Embodiment 35. The collapsible casket of embodiment 31, wherein the lid comprises a movable flange coupled to an end piece, wherein the flange is disposed in a groove disposed in the end piece.

Embodiment 36. The collapsible casket of embodiment 35, wherein the lid closing mechanism further comprises a protrusion joint adapted to house a protrusion defining an axis wherein the lid rotates from an open position to a closed position about the axis.

Embodiment 37. The collapsible casket of embodiment 31, further comprising a keeper adapted to lock an end piece to a side piece through a modified mortise and tenon joint, a hook and groove joint, or a combination thereof.

Embodiment 38. The collapsible casket of embodiment 31, wherein the casket comprises a base width W1, a top width W2, and wherein the ratio of W2/W1 is greater than 1, greater than 1.2, greater than 1.5, or greater than 2.

Embodiment 39. The collapsible casket of embodiment 1, wherein the casket comprises a polymer, a wood, a card board, or a combination thereof.

Embodiment 40. A kit for a collapsible casket comprising: a hollow base; at least one lid piece; a plurality of sides pieces; and a plurality of edge pieces, wherein the kit is adapted to be packaged to fit within a maximum combined length and girth of 165 inches.

This written description uses examples, including the best mode, and also to enable those of ordinary skill in the art to make and use the invention. The patentable scope of the invention is defined by the embodiments, and may include other examples that occur to those skilled in the art. Such other examples are intended to be within the scope of the embodiments if they have structural elements that do not differ from the literal language of the embodiments, or if they include equivalent structural elements with insubstantial differences from the literal languages of the embodiments. For example, embodiments may relate to rotational devices such as an electric motor, such as a windshield wiper motor), or axial sliding applications, such as a steering column adjustment mechanism.

While embodiments have been shown or described in only some of forms, it should be apparent to those skilled in the art that they are not so limited, but are susceptible to various changes without departing from the scope of the invention.

1. A collapsible casket comprising:
a hollow base comprising a frame and a plurality of internal intersecting members disposed interior to the frame.

2. The collapsible casket of embodiment 1, wherein the plurality of intersecting members interlock.

3. The collapsible casket of embodiment 2, wherein at least one of the plurality of intersecting members comprises a slot cut into the at least one intersecting member to interlock the plurality of members together.

4. The collapsible casket of embodiment 1, wherein the internal intersecting members form a polygon, a cross shape, an octothorpe, or any combination thereof.

5. The collapsible casket of embodiment 1, wherein the internal intersecting members extend outward longitudinally, laterally, diagonally, or a combination thereof, from the center of the base as viewed from above the base.

6. The collapsible casket of embodiment 1, wherein the internal intersecting members extend inward from the sides of the frame toward the center of the base as viewed from above the base.

7. The collapsible casket of embodiment 1, wherein the frame comprises at least two latitudinal pieces and at least two longitudinal pieces that interlock to form a rectangle.

8. The collapsible casket of embodiment 7, wherein the frame comprises a plurality of handles.

9. The collapsible casket of embodiment 8, wherein each handle comprises two lateral pieces positioned in parallel that are disposed to intersect across and with the two longitudinal pieces.

10. The collapsible casket of embodiment 9, wherein the handle further comprises a hand grip coupled to and disposed between the two lateral pieces at the distal ends of the lateral pieces.

11. The collapsible casket of embodiment 1 further comprising:
a lid;
a plurality of side pieces; and
a plurality of end pieces,
wherein the side pieces and the end pieces are coupled to each other and coupled to the base to form a polygonal shaped box.

12. The collapsible casket of embodiment 11, wherein at least one of the end pieces couples to at least one of the side pieces through a modified mortise and tenon joint, a hook and groove joint, or a combination thereof.

13. The collapsible casket of embodiment 11, wherein one of the end pieces comprises an arcuate top shape.

14. The collapsible casket of embodiment 11, wherein the lid comprises a plurality of lid pieces.

15. The collapsible casket of embodiment 11, wherein the lid comprises a movable flange coupled to an end piece, wherein the flange is disposed in a groove disposed in the end piece.

16. The collapsible casket of embodiment 15, wherein the lid closing mechanism further comprises a protrusion joint adapted to house a protrusion defining an axis wherein the lid rotates from an open position to a closed position about the axis.

17. The collapsible casket of embodiment 11, further comprising a keeper adapted to lock an end piece to a side piece through a modified mortise and tenon joint, a hook and groove joint, or a combination thereof.

18. The collapsible casket of embodiment 11, wherein the casket comprises a base width W₁, a top width W₂, and wherein the ratio of W₂/W₁ is greater than 1, greater than 1.2, greater than 1.5, or greater than 2.

19. The collapsible casket of embodiment 1, wherein the casket comprises a polymer, a wood, a card board, or a combination thereof.

20. A kit for a collapsible casket comprising:
a hollow base
at least one lid piece;
a plurality of sides pieces; and
a plurality of edge piece, wherein the kit is adapted to be packaged to fit within a maximum combined length and girth of 165 inches.
